(19) United States
(12) Patent Application Publication
(10) Pub. No.: US 2015/0370891 A1
(43) Pub. Date: Dec. 24, 2015

(54) METHOD AND SYSTEM FOR RETRIEVING CONTENT

(71) Applicants: SONY CORPORATION, Tokyo (JP); SONY NETWORK ENTERTAINMENT INTERNATIONAL LLC, Los Angeles, CA (US)

(72) Inventor: Brian Johnson, San Francisco, CA (US)

(21) Appl. No.: 14/310,131

(22) Filed: Jun. 20, 2014

(51) Int. Cl. G06F 17/30; G06F 3/0482

(52) U.S. Cl. CPC G06F 17/30681; G06F 3/0482

(57) ABSTRACT

Various aspects of a method and a system for retrieving content are disclosed herein. The method includes receiving a search query comprising a string of characters from a user. A set of search results are determined from a plurality of pre-stored strings of characters, based on a phonetic similarity with the received search query.

### FIELD

Various embodiments of the disclosure relate to retrieving content. More specifically, various embodiments of the disclosure relate to retrieving content based on a phonetic similarity with a search query.

### BACKGROUND

With the advent of new search methodologies, a user may efficiently retrieve desired content (such as music files, multimedia content, and/or gaming applications) from a local or remote database. To retrieve such desired content, the user may be required to provide a search query. In certain scenarios, the language of the retrieved content may be similar to the language of the search query provided by the user. In such scenarios, the user may not be able to retrieve content in languages other than the language of the search query.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A method and a system is provided for retrieving content substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for retrieving content, in accordance with an embodiment of the disclosure.

FIG. 2 is a block diagram illustrating a computing device, in accordance with an embodiment of the disclosure.

FIG. 3 illustrates an exemplary interface of a computing device, in accordance with an embodiment of the disclosure.

FIG. 4 is a flow chart illustrating a method for retrieving content, in accordance with an embodiment of the disclosure.

### DETAILED DESCRIPTION

The following described implementations may be found in a method and a system for retrieving content. Exemplary aspects of the disclosure may comprise a method that may comprise receiving a search query from a user. The search query may comprise a string of characters. The method may further comprise determining a set of search results from a plurality of pre-stored strings of characters. The determination may be based on a phonetic similarity with the received search query. In an embodiment, the determination may be based on a phonetic similarity between one or more character groups of each of the plurality of pre-stored strings of characters and the received search query.

In an embodiment, the string of characters may correspond to one of a plurality of scripts of a language, or a plurality of languages. In an embodiment, the plurality of scripts correspond to: Hiragana characters, Kanji characters, Katakana characters, or Romaji characters of Japanese language.

In an embodiment, the determined set of search results may comprise one or more strings of characters from at least one other of the plurality of scripts that are phonetically similar to the received search query. In an embodiment, the method comprises displaying a list of input characters corresponding to the one of the plurality of scripts for selection by the user. In an embodiment, the list of input characters may be updated dynamically based on the selection by the user.

In an embodiment, the method comprises dynamically updating the set of search results based on the user selection. In an embodiment, the method comprises sorting the set of results based on a position of one or more phonetically similar character groups in the set of search results. The position of the one or more phonetically similar character groups in the set of search results corresponds to one of: a start or an end of the set of search results.

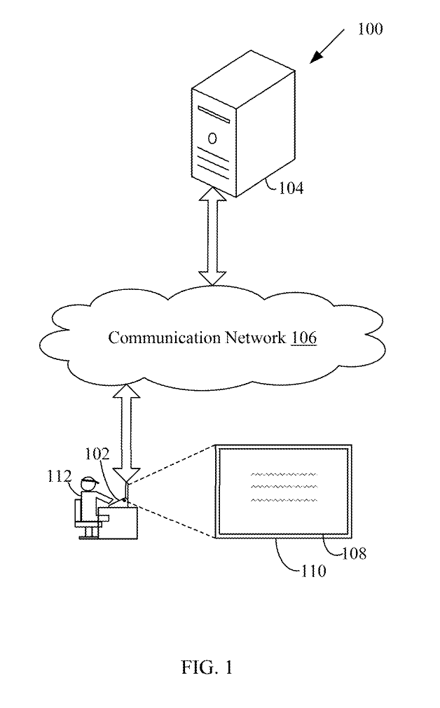

FIG. 1 is a block diagram illustrating a network environment, in accordance with an embodiment of the disclosure. With reference to FIG. 1, there is shown a network environment 100. The network environment 100 may comprise a computing device 102, an application server 104, a communication network 106, a user interface 108, a display screen 110, and a user 112. The computing device 102 may be communicatively coupled to the application server 104, via the communication network 106. The computing device 102 may be associated with the user 112. The user 112 may interact with the computing device 102, via the user interface 108, rendered on the display screen 110.

The computing device 102 may comprise suitable logic, circuitry, interfaces, and/or code that may be operable to receive an input, such as a search query, from the user 112. The computing device 102 may be further operable to render an output based on the received input. Examples of the computing device 102 may include, but are not limited to, gaming consoles, laptops, tablet computers, smartphones, and/or Personal Digital Assistant (PDA) devices. Although for simplicity, FIG. 1 shows only the computing device 102 associated with the user 112, one skilled in the art may appreciate that the disclosed embodiments may be implemented for a larger number of computing devices and associated users in the network environment 100 and remain within the scope of the disclosure.

The application server 104 may comprise suitable logic, circuitry, interfaces, and/or code that may be operable to host one or more applications for the computing device. In an embodiment, the one or more applications may be associated with respective user interfaces, such as the user interface 108, rendered on the display screen 110.

The communication network 106 may comprise suitable logic, circuitry, interfaces, and/or code that may provide a medium through which the computing device 102 may communicate with the application server 104. Examples of the communication network 106 may include, but are not limited to, the Internet, a Wireless Fidelity (Wi-Fi) network, a Wireless Local Area Network (WLAN), a Local Area Network (LAN), a telephone line (POTS), and/or a Metropolitan Area Network (MAN). The computing device 102 and the application server 104 may be operable to communicate via the communication network 106, in accordance with various wired and wireless communication protocols. Examples of such communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The display screen 110 may comprise suitable logic, circuitry, interfaces, and/or code that may be operable to render the user interface 108, which corresponds to one or more applications hosted by the application server 104. The display screen 110 may be further operable to display one or more features and/or applications of the computing device 102. In an embodiment, the display screen 110 may be further operable to receive an input from the user 112, via a touch-sensitive screen. The display screen 110 may be realized through several known technologies, such as, but not limited to, Liquid Crystal Display (LCD) display, Light Emitting Diode (LED) display, and/or Organic LED (OLED) display technology.

The user interface 108 may be a graphical user interface (GUI) that may be rendered on the display screen 110 of the computing device 102. The user interface 108 may enable the user 112 to access, retrieve, view, and/or execute the one or more applications hosted by the application server 104. In an embodiment, the user interface 108 may further enable the user 112 to access, retrieve, view, and/or execute offline applications stored in a local memory of the computing device 102. In an embodiment, the user 112 may install a software application (not shown) on the computing device 102, to present the user interface 108.

In operation, the user 112 may provide a search query to the computing device 102. In an embodiment, the search query may comprise a string of alphanumeric characters. In an embodiment, the string of alphanumeric characters may correspond to at least one language of a plurality of languages. Examples of such one or more languages may include, but are not limited to, English, Japanese, German, and/or Hindi.

In an embodiment, the string of alphanumeric characters may be selected from a plurality of scripts, which corresponds to the at least one language. For example, with reference to the Japanese language, a plurality of scripts may include, but is not limited to, Hiragana characters, Kanji characters, Katakana characters, and/or Romaji characters. In an embodiment, the search query may be a combination of one or more of: the Hiragana characters, the Kanji characters, the Katakana characters, and/or the Romaji characters.

In an embodiment, the computing device 102 may be operable to determine a set of search results based on the received search query. The set of search results may be determined from a plurality of pre-stored strings of alphanumeric characters. In an embodiment, the plurality of pre-stored strings of alphanumeric characters may be stored in a local memory of the computing device 102. In an embodiment, the plurality of pre-stored strings of alphanumeric characters may be pre-stored in a remote memory (not shown), communicatively coupled to the computing device 102, via the communication network 106.

In an embodiment, each of the plurality of pre-stored strings of alphanumeric characters may comprise one or more character groups. In an embodiment, the one or more character groups may be composed of a first set of characters, which corresponds to a first language and/or script. The first language and/or script may correspond to the at least one language and/or script of the plurality of languages and/or scripts.

In another embodiment, the one or more character groups may comprise a second set of characters, which correspond to a second language and/or script. The second language and/or script may correspond to a different language and/or script compared to the at least one language and/or script of the plurality of languages and/or scripts.

In an embodiment, the computing device 102 may be operable to determine the set of search results, based on a phonetic similarity between the one or more character groups and the received search query. In an embodiment, the computing device 102 may be operable to sort the set of search results, based on a position of the one or more character groups in each of the plurality of pre-stored strings of characters. In an embodiment, the position of the one or more character groups in each of the plurality of pre-stored strings of alphanumeric characters, may be a start or an end of the plurality of pre-stored strings of alphanumeric characters that correspond to each of the set of search results.

In an embodiment, the functionality similar to the computing device 102, may be performed by the application server 104. In such an embodiment, the computing device 102 may be operable to provide the user interface 108 to the user 112, via the display screen 110. The user 112 may input the search query via the user interface 108. In such an embodiment, the application server 104 may be communicatively coupled to the remote memory (not shown). The remote memory may be operable to store the plurality of pre-stored strings of alphanumeric characters. The application server 104 may be operable to retrieve one or more of the plurality of pre-stored strings of alphanumeric characters from the remote memory, via the communication network 106. Based on one or more of the plurality of pre-stored strings of alphanumeric characters retrieved from the remote memory, the application server 104 may determine a set of search results. The application server 104 may transmit the set of search results to the computing device 102. The computing device 102 may be operable to render the received set of search results on the user interface 108.

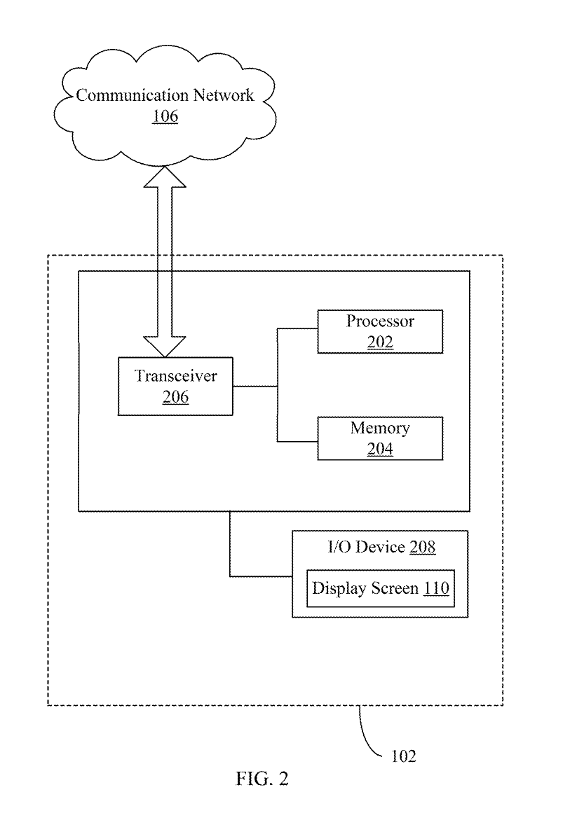

FIG. 2 is a block diagram illustrating a computing device, in accordance with an embodiment of the disclosure. FIG. 2 is explained in conjunction with elements from FIG. 1. With reference to FIG. 2, there is shown the computing device 102. The computing device 102 may comprise one or more processors, such as a processor 202, a memory 204, a transceiver 206, and one or more Input-Output (I/O) devices, such as an I/O device 208. The processor 202 may be communicatively coupled to the memory 204, and the I/O device 208. Further, the transceiver 206 may be communicatively coupled to the processor 202, the memory 204, and the I/O device 208. Further, the transceiver 206 may be communicatively coupled to the application server 104, via the communication network 106.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a Reduced Instruction Set Computing (RISC) processor, an Application-Specific Integrated Circuit (ASIC) processor, a Complex Instruction Set Computing (CISC) processor, or other processor.

The memory 204 may comprise suitable logic, circuitry, interfaces, and/or code that may be operable to store a set of instructions executable by the processors 202. The memory 204 may further store data related to the plurality of languages and/or scripts. The memory 204 may be further operable to pre-store the plurality of strings of alphanumeric characters. The plurality of pre-stored strings of alphanumeric characters may correspond to one or more languages of the plurality of languages. The memory 204 may store a repository, which may include a phoneme, associated with the one or more character groups of each of the plurality of pre-stored strings of alphanumeric characters. The memory 204 may further include at least one phonetic algorithm, which may be utilized to index a character group of alphanumeric characters based on their pronunciation. Examples of such phonetic algorithms, may include, but are not limited to, the Metaphone Algorithm and/or Soundex Algorithm. The memory 204 may be implemented based on, but not limited to, a Random Access Memory (RAM), a Read-Only Memory (ROM), a Hard Disk Drive (HDD), a storage server and/or a Secure Digital (SD) card.

The transceiver 206 may comprise suitable logic, circuitry, interfaces, and/or code that may be operable to communicate with the application server 104, via various communication interfaces. The transceiver 206 may implement known technologies to support wired or wireless communication with the communication network 106. The transceiver 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN), and other devices. The wireless communication may use a plurality of communication standards, protocols and technologies, which include, but are not limited to, the Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 208 may comprise various input and output devices that may be operable to receive an input from a user, or provide an output to the user. The I/O device 208 may comprise various input and output devices that may be operable to communicate with the processor 202. Examples of the input devices may include, but are not limited to, a keyboard, a mouse, a joystick, a touch screen, a microphone, a camera, a motion sensor, a light sensor, and/or a docking station. Examples of the output devices may include, but are not limited to, the display screen 110, and/or a speaker.

In operation, the processor 202 of the computing device 102, may be operable to receive the search query from the user 112. The search query may comprise a string of characters, which may be selected by the user 112 from a list of alphanumeric characters. In an embodiment, the list of alphanumeric characters may be scrolled through and a character may be selected using the I/O device 208, which may be a pointing device. The list of alphanumeric characters may correspond to at least one language (hereafter referred to as an input language and/or script), stored in the memory 204. In an embodiment, the user 112 may select the input language from the plurality of languages, via the user interface 108. In another embodiment, the user 112 may select a script from the plurality of scripts, which correspond to a language from the plurality of languages.

For example, the user 112 may select the input language as, “English”. Based on the selected English language, the processor 202 may be operable to render a list of English characters, such as the list “A-Z”, on the user interface.

In another example, the user 112 may select a Hiragana script of Japanese language as the input language. The processor 202 may be operable to render a list of Hiragana characters on the user interface. In an embodiment, the list of alphanumeric characters may further comprise special characters and numbers, such as “−”, “@”, “#”, “1”, “2”, “3”, and/or the like. In an embodiment, the string of characters may be selected by the user 112, one character at a time. For every character that is selected, the processor 202 may be operable to dynamically update the list of alphanumeric characters rendered on the user interface.

In an embodiment, when a character is selected from the list of alphanumeric characters, the processor 202 may be operable to suggest one or more words from the input language/script to the user 112. The one or more words may be suggested based on a prediction algorithm, which may be stored in the memory 204. The user 112 may then select a desired word from the one or more words, as a part of the search query.

In an embodiment, the processor 202 may be operable to extract a phoneme, associated with the search query. The associated phoneme may be extracted based on the at least one phonetic algorithm stored in the memory 204. In an embodiment, the processor 202 may be operable to determine a search result from the plurality of pre-stored strings of alphanumeric characters, based on the phoneme associated with the search query. In an embodiment, the processor 202 may determine the search result when the phoneme associated with at least one character group of a pre-stored string of alphanumeric characters is similar to the phoneme associated with the search query. In an embodiment, the at least one phonetically similar character group of the search result may be composed of the first set of characters and/or the second set of characters.

In a first exemplary scenario, a list of characters “A-Z”, which correspond to the English language, is rendered on the user interface 108. The user 112 may select a string of characters “CA” from the list of characters “A-Z”. The processor 202 may determine a phoneme associated with “CA” as “ka”, by using one or more phonetic algorithms. The one or more phonetic algorithms may be retrieved from the memory 204.

In accordance with the first exemplary scenario, a first pre-stored string “CARNATION”, may comprise the selected string of characters. A first character group is “CAR”, which corresponds to a first phoneme “kär”. A second character group is “NA”, which corresponds to a second phoneme “nā′”. A third character group is “TION”, which corresponds to a third phoneme “sh [symbol] n”. Since the first phoneme “kär”, which corresponds to “CAR”, is phonetically similar to “kä”, the first pre-stored string “CARNATION”, may be determined as a first search result by the processor 202. Similarly a second pre-stored string “CAR”, and a third pre-stored string “SOCCER” comprises characters groups “CA” and “CE”, respectively. The phonemes “kä” and “k′ [symbol] ”, associated with the characters groups “CA” and “CE”, are similar to the phoneme “kä”, associated with the selected string of characters “CA”. Based on the similar phonetics, the processor 202 may determine a second search result and a third search result, respectively.

For example, in the first exemplary scenario mentioned above, the processor 202 may further determine a fourth pre-stored string, “ [symbol] ” from the Hindi language, which comprises the character group, “ [symbol] ”, which is phonetically similar to “kä”. The processor 202 may determine the set of search results as, “CARNATION”, “CAR”, “SOCCER”, and “ [symbol] ”.

In an embodiment, the processor 202 may be operable to sort the set of search results based on the alphabetical sequence of each language/script of the plurality of languages and/or scripts. For example, in the first exemplary scenario, the set of search results may be displayed in an output sequence, “CAR”, “CARNATION”, “SOCCER” and “ [symbol] ”. The output sequence may be based on the sequence of the plurality of languages and/or the alphabetical sequence of each of the plurality of languages and/or scripts.

In an embodiment, the processor 202 may be further operable to sort the set of search results based on a position of the text, which corresponds to the at least one phonetically similar character group in each search result of the set of search results. In such an embodiment, the position of text, which corresponds to the at least one phonetically similar character group, may correspond to one of a start position or an end position of at least one search result of the set of search results. With reference to the first exemplary scenario, the processor 202 may determine a first position of the character group “CA”, as a start position for the first search result “CARNATION”. The processor 202 may further determine a second position of the character group “CA”, as a start position for the second search result “CAR”. In such an embodiment, the processor 202 may be operable display the one or more search results, of the set of search results, on the user interface 108, rendered on the display screen 110.

In an embodiment, the processor 202 may be operable not to display one or more search results, of the set of search results, for which the position of the character group in the pre-stored string of alphanumeric characters is a middle position. With reference to the first exemplary scenario, the processor 202 may not display “SOCCER”, as one of the set of search results, as the phoneme “k′ [symbol] ”, is associated to the character group “CE”, which corresponds to a middle position.

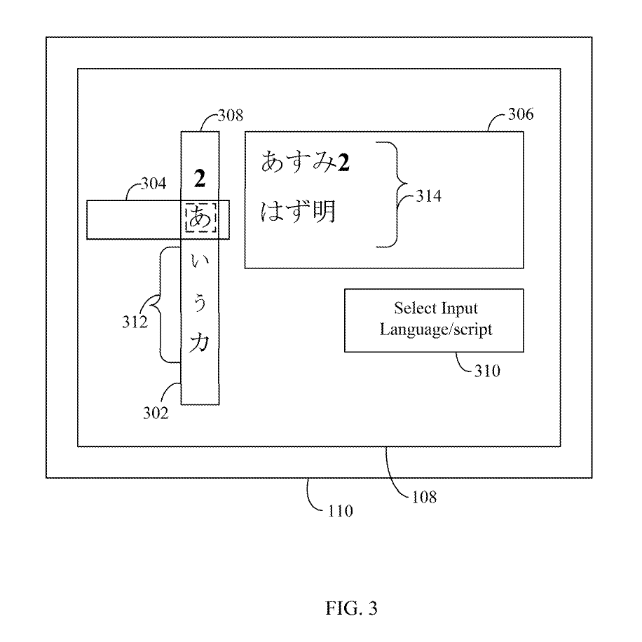

FIG. 3 illustrates an exemplary interface of an exemplary computing device, in accordance with an embodiment of the disclosure. FIG. 3 is explained in conjunction with elements from FIG. 1, and FIG. 2. With reference to FIG. 3, there is shown the display screen 110, which renders the user interface 108. The user interface 108 may correspond to an application executed at the computing device 102, which may retrieve content based on the input provided by the user 112. The user interface 108 may comprise a first display segment 302, a second display segment 304, a third display segment 306, and a highlighter 308. The user interface 108 may further comprise a first option, “Select Input Language” 310. The first display segment 302 may comprise a list of alphanumeric characters 314 that may be selected by the user 112. The second display segment 304 may display the search query that comprises the string of alphanumeric characters 318, selected by the user 112, from the list of alphanumeric characters 314. The third display segment 306 may display a set of search results, phonetically similar to the search query.

In an embodiment, the user 112 may select an input language from a plurality of languages, based on the first option 310. In an embodiment, the user 112 may scroll through the list of alphanumeric characters 314, which correspond to the input language, via the I/O device 208, which may be a mouse.

In an embodiment, the user 112 may move the highlighter 308 to select a string of characters, from the list of alphanumeric characters 314. The selected string of characters may correspond to a search query. In an embodiment, the user 112 may scroll the list of alphanumeric characters 314, such that a desired character is highlighted based on a position of the highlighter 308. The user 112 may select a sequence of desired characters to generate a string of characters. The second display segment 304 may display the string of alphanumeric characters 318, selected by the user 112 from the list of alphanumeric characters 314.

In a second exemplary scenario, when the user 112 selects the Hiragana script from the first option 310, the list of alphanumeric characters, which correspond to Hiragana characters “2 1 [symbol] ”, may be vertically displayed on the first display segment 302. The user 112 selects a character, “ [symbol] ”, from the displayed list of Hiragana characters via the highlighter 308. The selected alphanumeric character, “ [symbol] ”, may be displayed on the second display segment 304. The processor 202 may determine a phoneme associated with “ [symbol] ” as “ [symbol] ”, by using one or more phonetic algorithms. The one or more phonetic algorithms may be retrieved from the memory 204.

In accordance with the second exemplary scenario, a first pre-stored string “ [symbol] ”, may comprise one or more character groups. The first character group may be “ [symbol] ”, which corresponds to a first phoneme “ha”. A second character group may be “ [symbol] ”, which corresponds to a second phoneme “zu”. A third character group may be “ [symbol] ”, which corresponds to a third phoneme “α:k [symbol] ”. Since the phoneme associated with the third character group “α:k [symbol] ”, is phonetically similar to “ [symbol] ”, the first pre-stored string “ [symbol] ”, may be determined as a first search result by the processor 202. In accordance with the second exemplary scenario, “ [symbol] ” and “ [symbol] ” correspond to Hiragana script, while “ [symbol] ” corresponds to Kanji script. The processor 202 may determine a position of text as “end”, which corresponds to a position of the phonetically similar third character group of the first search result. A fourth phoneme associated with a first character group “ [symbol] ” of a second, pre-stored string “ [symbol] 2”, is “ [symbol] ”. Hence the processor 202 may further determine “ [symbol] 2”, as a second search result of the set of search results.

In an embodiment, the processor 202 may display the set of search results in the third display segment 306. The set of search results may be based on the phonetic similarity of the one or more character groups of the pre-stored string of alphanumeric characters to the received search query. The displayed set of results may be sorted by the processor 202 for display to the user 112. The sorting may be based on a position of phonetically similar character groups from the set of search results.

In accordance with the second exemplary scenario, the processor 202 may determine a first position of text as “end”, which corresponds to a position of the phonetically similar “ [symbol] ” of the first search result, “ [symbol] ”. The processor 202 may further determine a second position of text as “first”, which corresponds to a position of the phonetically similar “ [symbol] ” of the second search result “ [symbol] 2”. Hence the set of results may be displayed on the third display segment 306 as “ [symbol] 2” followed by “ [symbol] ”.

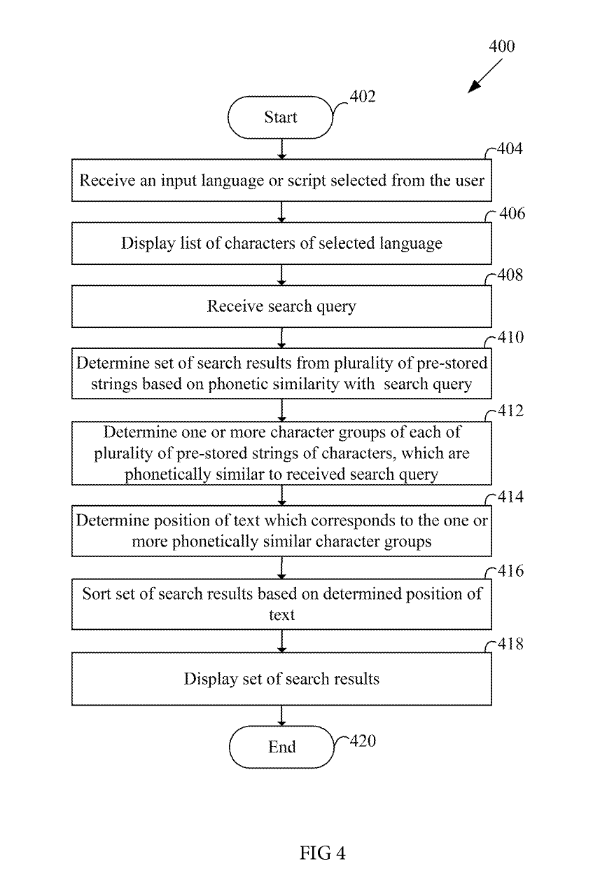

FIG. 4 is a flowchart illustrating a method for retrieving content, in accordance with an embodiment of the disclosure. FIG. 4 is described in conjunction with elements of FIG. 1 and FIG. 2. The method 400 may be implemented in the computing device 102, communicatively coupled to the application server 104, via the communication network 106.

The method 400 begins at step 402. At step 404, an input language and/or script, selected by the user 112, may be received. At step 406, the list of characters, which corresponds to the input language, may be displayed on the user interface 108. At step 408, a search query may be received from the user 112. The search query may comprise a string of characters selected from a list of characters displayed on the display screen 110.

At step 410, the set of search results may be determined from the plurality of pre-stored strings, based on a phonetic similarity with the received search query. At step 412, one or more character groups of each of the plurality of pre-stored strings of alphanumeric characters, which are phonetically similar to the received search query, may be determined.

At step 414, a position of text, which corresponds to the one or more character groups, may be determined. At step 416, the set of search results may be sorted, based on the determined position of the one or more character groups. At step 418, the sorted set of search results may be rendered on the display screen 110. Control passes to end step 418.

In accordance with another embodiment of the disclosure, a system for retrieving content desired by the user 112 is disclosed. The computing device 102 (FIG. 1) may comprise one or more processors (hereinafter referred to as the processor 202 (FIG. 2)). The processor 202 may be operable to receive a search query comprising a string of characters from a user. The processor 202 may be further operable to determine a set of search results from a plurality of pre-stored strings of characters, based on a phonetic similarity with the received search query.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer for retrieving content. The at least one code section in a computing device may cause the machine and/or computer to perform the steps comprising receiving a search query comprising a string of characters from a user. Based on a phonetic similarity with the received search query, a set of search results may be determined from a plurality of pre-stored strings of characters.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for retrieving content, said method comprising:
in a computing device:
receiving a search query comprising a string of characters from a user; and
determining a set of search results from a plurality of pre-stored strings of characters based on a phonetic similarity with said received search query.

2. The method of claim 1, wherein said determination is based on a phonetic similarity between one or more character groups of each of said plurality of pre-stored strings of characters and said received search query.

3. The method of claim 1, wherein said string of characters corresponds to one of: a plurality of scripts of a language or a plurality of languages.

4. The method of claim 3, wherein said plurality of scripts correspond to: Hiragana characters, Kanji characters, Katakana characters, or Romaji characters of Japanese language.

5. The method of claim 3, comprising displaying a list of input characters corresponding to one of: said plurality of scripts or said plurality of languages, wherein said string of characters corresponds to one or more input characters selected from said displayed list of input characters.

6. The method of claim 5, comprising dynamically updating said list of input characters based on said selection by said user.

7. The method of claim 5, comprising dynamically updating said set of search results based on said selection by said user.

8. The method of claim 1, wherein said set of search results are sorted based on a position of said one or more character groups phonetically similar with said received search query.

9. The method of claim 8, wherein said position of said one or more character groups in said pre-stored character strings correspond to one of: a start or an end of said pre-stored character strings.

10. A system for retrieving content, said system comprising:
one or more processors in a computing device, said one or more processors are operable to:
receive a search query comprising a string of characters from a user; and
determine a set of search results from a plurality of pre-stored strings of characters based on a phonetic similarity with said received search query.

11. The system of claim 10, wherein said determination is based on a phonetic similarity between one or more character groups of each of said plurality of pre-stored strings of characters and said received search query.

12. The system of claim 11, wherein said string of characters corresponds to one of:
a plurality of scripts of a language or a plurality of languages.

13. The system of claim 12, wherein said plurality of scripts correspond to: Hiragana characters, Kanji characters, Katakana characters, or Romaji characters of Japanese language.

14. The system of claim 13, wherein said one or more processors are operable to display a list of input characters corresponding to said one of said plurality of scripts for selection by said user.

15. The system of claim 14, wherein said one or more processors are operable to dynamically update said list of input characters based on said selection by said user.

16. The system of claim 14, wherein said one or more processors are operable to dynamically update said set of search results based on said selection by said user.

18. The system of claim 10, wherein said set of search results are sorted based on a position of said one or more character groups phonetically similar with said received search query.

19. The system of claim 18, wherein said position of said one or more character groups in said pre-stored character strings correspond to one of: a start or an end of said pre-stored character strings.

20. A non-transitory computer readable storage medium, having stored thereon, a program having at least one code section executable by a processor, thereby causing said processor to perform steps comprising:
receiving a search query comprising a string of characters from a user; and
determining a set of search results from a plurality of pre-stored strings of characters based on a phonetic similarity with said received search query.
